(19) United States
(12) Patent Application Publication
(10) Pub. No.: US 2014/0144654 A1
(43) Pub. Date: May 29, 2014

(54) Furrow Opener with Replaceable Tip and Accompanying Replaceable Piece

(71) Applicant: Atom Jet Industries (2002) Ltd., (US)

(72) Inventors: Don Arksey, Brandon (CA); Noel Lagarde, Brandon (CA); Marcel Lanoie, Brandon (CA)

(21) Appl. No.: 13/869,461

(22) Filed: Apr. 24, 2013

Related U.S. Application Data
(60) Provisional application No. 61/638,872, filed on Apr. 26, 2012.

(51) Int. Cl. A01B 15/02

(52) U.S. Cl. CPC A01B 15/02
USPC 172/772.5; 29/428

(57) ABSTRACT

A furrow opener features an opener body including a shank mount and upper and lower interface portions at a forward side of the opener body. A replaceable tip body has a furrowing portion for opening a furrow in the ground, a top interface portion at its rear for mating with the upper interface portion of the opener body and a rear accommodating portion defining an accommodating space between the opener body and the tip body when the top interface portion is mated to the opener body. An intermediate body has a mounting portion arranged to interface with the rear accommodating portion of the tip body and the lower interface portion of the opener body to fit in the accommodating space defined therebetween. The tip and intermediate bodies are separately replaceable, thereby accounting for different rates of wear at different areas of the opener.

### CROSS REFERENCE TO RELATED APPLICATIONS

This application claims benefit under 35 U.S.C. 119(e) of U.S. Provisional Patent Application Ser. No. 61/638,872, filed Apr. 26, 2012.

### FIELD OF THE INVENTION

The present invention relates generally to agricultural furrow openers having replaceable tips, and more particular to an opener wherein the replaceable tip body is arranged to mount on the opener body in combination with a second replaceable body, which in some embodiments forms a wing on one or both sides of the tip so that the tip and associated wing(s) can be replaced together or separately according to their respective degrees of wear.

### BACKGROUND OF THE INVENTION

Furrow openers are used in agriculture to create furrows in the ground for delivery of one more materials thereinto, for example seed, fertilizer or a combination thereof. The openers features bodies that are attached to shanks that depend down toward the ground from the frame of an implement being conveyed over the ground in a forward working direction, typically a wheeled implement towed in such direction by a suitable vehicle, such as an agricultural tractor. It is known to use a removably mounted piece or body at lower forward point on the opener body to form the tip of the opener that depends into the ground in a position leading the one more delivery channels or conduits through which material is dropped into the furrow formed by the displacement of earth as the tip rips through the ground. The use of a removable piece to form the tip allows the tip to be replaced without replacement of the rest of the opener, as the tip experiences the greatest wear of all the opener components due to its leading position cutting through the ground.

Openers of various configurations are known in the art, including single shoot openers that deploy a single material (e.g. seed or fertilizer) from a central discharge opening at a central location across the furrow, and double shoot openers that deploy one material, (e.g. fertilizer) from a central discharge opening and one or more side rows of other material (e.g. seed) each off to a respective side of the central row of the first material. Side banding openers use a single laterally positioned outlet spaced off to one side from the central opening to deliver the one laterally positioned row of material, while paired row openers feature to lateral outlets on respective sides of the central opening to deliver two rows of the second material on opposite sides of the single central row of the first material.

Side banding and paired row openers feature one or two wing-shaped features respectively, each wing projecting off to the respective side of the tip on the central portion of the opener body that attaches to the implement shank, whereby the wing leads the respective lateral outlet of the opener to clear space into which the second material is delivered through that outlet. The wing angles upward from front to back so that the soil rides up and over the wing to fall back in place over the material delivered to the furrow flow just behind the outlet.

In prior art replaceable tip openers with side banding or paired row wings projecting to one or both sides of the tip, the wings have been formed as integral parts of the tip body. Accordingly, should the tip and wing(s) wear at different rates under ongoing use of the opener, the wearing of one such feature to a level requiring replacement means that the other integral feature is also replaced, regardless of whether its condition makes such replacement necessary.

Applicant has developed a new replaceable tip system for an opener, where a multi-piece construction allows replacement of the tip and lateral wing(s) at separate times.

### SUMMARY OF THE INVENTION

According to a first aspect of the invention there is provided a furrow opener for mounting on an agricultural implement shank for movement therewith in a forward working direction, the furrow opener comprising:

an opener body including a shank mount arranged to support the opener body on the implement shank, and upper and lower interface portions at a forward side of the opener body;

a tip body comprising:
a top interface portion adjacent an upper end of the tip body and arranged for mating with the upper interface portion of the opener body so as to interface the tip body with the opener body at a distance upward from a bottom end of the opener body;
a rear accommodating portion defined at the rear side of the tip body below the top interface portion and arranged to define an accommodating space between the lower interface portion of the opener body at the forward side thereof and the rear accommodating portion of the tip body with the top interface portion of the tip body mated with the upper interface portion of the opener body; and
a furrowing portion extending downwardly and forwardly from the accommodating portion to reach beyond the bottom end of the opener body so as to be arranged to form a furrow in the ground; and

an intermediate body comprising a mounting portion arranged to interface with the rear accommodating portion of the tip body and the lower interface portion of the opener body to fit in the accommodating space defined therebetween.

Preferably a rear side of the intermediate body is arranged to embrace about the forward side of the opener body onto opposing lateral sides thereof.

Preferably the tip body comprises an embracing portion at the rear side thereof, which is arranged to embrace about the forward side of the opener body onto opposing lateral sides thereof.

Preferably the embracing portion of the tip body is disposed below the top interface portion and above the rear accommodating portion.

Preferably the top interface portion of the tip body and the upper interface portion of the opener body comprise opposite ones of a socket and a projection matably receivable in said socket.

Preferably the upper interface portion of the opener body comprises the socket, which opens downward and comprises side walls for fitting over respective lateral sides of the projection, which extends upwardly on the tip body.

Preferably there are provided aligned holes passing through the side walls of the socket, a corresponding through hole passing transversely through the projection at a position aligning with the aligned holes of the socket when the projection is matingly received therein, and a retaining pin for passage through the aligned holes of the socket and the through hole of the projection when same are aligned.

Preferably the socket and the projection are wedge-shaped to each grow wider from front to back moving in a downward direction due to downward and forward sloping at a front of the socket and the projection relative to a vertical rear of the socket and the projection.

Preferably a rear side of the intermediate body and the lower interface portion of the opener body feature opposite ones of a slot and a tongue matably receivable in said slot.

Preferably the intermediate body comprises a forward jutting feature at a front side thereof and the tip body comprises a rearward jutting feature at the rear accommodating portion thereof, the forward jutting feature of the intermediate body being arranged to fit over the rearward jutting feature of the tip body to suspend the intermediate body from the tip body.

Preferably the intermediate body is one of a plurality of intermediate bodies each comprising a respective said mounting portion arranged to fit within the accommodating space between the tip body and the opener body, and each having a different respective number, between zero and two, of wing portions each projecting laterally outward from the respective mounting portion on a respective lateral side thereof, whereby the intermediate body is selectable from among the plurality of intermediate bodies according to a numbering and positioning of product discharge locations on the opener body.

The intermediate body may have a single wing portion projecting laterally outward from the mounting portion on only one side thereof, and the opener body has a lateral discharge opening on only one side thereof in a position trailing the single wing portion of the intermediate body.

Alternatively, the intermediate body may have a pair of wing portions projecting laterally outward from the mounting portion on opposite sides thereof, and the opener body has a pair of lateral discharge openings on opposing sides thereof in positions respectively trailing the wing portions of the intermediate body.

As a further alternative, the intermediate body may be free of any wing portions projecting laterally outward from the mounting portion thereof, and the opener body has a central discharge opening in a position trailing the mounting portion of the intermediate body.

Preferably the tip body and the intermediate body are arranged to be secured in place relative to the opener body through fastening of only a single fastener.

Said fastener may engage the opener body and only one of said tip body or said intermediate body.

Alternatively, there may be provided a single fastener engaging with the opener body and both the tip body and intermediate body, for example a vertical bolt passing through the tip body and opener body along the front of the opener body.

Preferably the intermediate body is arranged to be clamped in place between the tip body and the opener body under fastening of the tip body to the opener body with the intermediate body in the accommodating space, without additional fastening of the intermediate body to either the tip body or the opener body.

Preferably there is provided a fastening arrangement operable to fasten the tip body to the opener body where the upper interface portion of the opener body mates with the top interface portion of the tip body.

According to a second aspect of the invention there is provided a method of mounting a tip body on an opener body of a furrow opener in which the opener body comprises a shank mount arranged to support the opener body on an agricultural implement shank for movement therewith in a forward working direction, the method comprising:

positioning the tip body together with an intermediate body such that a top interface portion of the tip body engages with an upper interface portion at a forward side of the opener body, a rear side of the tip body engages with a front side of the intermediate body, a rear side of the intermediate body engages with the forward side of the opener body below the engagement between the top interface portion of the tip body and the upper interface portion of the opener body, and a furrowing portion of the tip body extend downwardly and forwardly from the engagement thereof with the intermediate body to extend past a bottom end of the opener body; and

fastening at least one of the tip body and the intermediate body to the opener body.

Preferably the method involves fastening only one of the tip body and the intermediate body to the opener body, wherein the fastening cooperates with the engagement between the bodies to secure the other of the tip body and the intermediate body to the opener body without additional fastening therebetween.

Preferably the method involves fastening the tip body to the opener body at the engagement of the top interface portion of the tip body with the upper interface portion of the opener body.

Preferably the method involves first selecting the intermediate body from a plurality of intermediate bodies each having a mounting portion suitably shaped to fit between the tip body and opener body, each of the plurality of intermediate bodies having a different number of wing portions projecting laterally from the mounting portion, wherein the selection involves matching the number of wing portions of the selected intermediate body to a number of lateral material discharge locations found at lateral positions on the opener body so that each lateral material discharge location on the opener body is led by a respective wing portion of the intermediate body in the forward working direction.

### BRIEF DESCRIPTION OF THE DRAWINGS

In the accompanying drawings, which illustrate exemplary embodiments of the present invention:

FIGS. 1A, 1B, 1C and 1D are perspective, front, side and overhead plan views of a single shoot opener of the present invention, featuring a replaceable tip body and a separately replaceable intermediate body between the tip body and the opener body.

FIGS. 2A, 2B, 2C and 2D are perspective, front, side and overhead plan views of a paired row opener of the present invention, but with a cap piece at the front of the opener body omitted from illustration.

FIGS. 3A, 3B, 3C, 3D and 3E are perspective, front, side, rear and overhead plan views of the replaceable tip body of the openers of FIGS. 1 and 2.

FIGS. 4A, 4B, 4C, 4D and 4E are perspective, front, side, rear and overhead plan views of the replaceable intermediate body of the opener of FIG. 1.

FIGS. 5A, 5B, 5C, 5D and 5E are perspective, front, side, rear and overhead plan views of the replaceable intermediate body of the opener of FIG. 2.

FIGS. 6A, 6B, 6C, 6D and 6E are perspective, front, side, rear and overhead plan views of the replaceable intermediate body for a side banding opener of the present invention.

FIGS. 7A, 7B, 7C and 7D are perspective, front, side and overhead plan views of the cap piece of the opener of FIG. 1.

FIGS. 8A, 8B, 8C and 8D are perspective, front, side and overhead plan views of an alternate design of the cap piece of FIG. 7.

FIGS. 9A, 9B, 9C, 9D and 9E are front perspective, front elevational, side elevational, bottom plan, and rear perspective views of a side banding opener of the present invention.

FIGS. 10A, 10B, 10C and 10D are perspective, front, side and bottom plan views of the cap piece of the opener of FIG. 9, which can also be used on the other illustrated openers.

### DETAILED DESCRIPTION

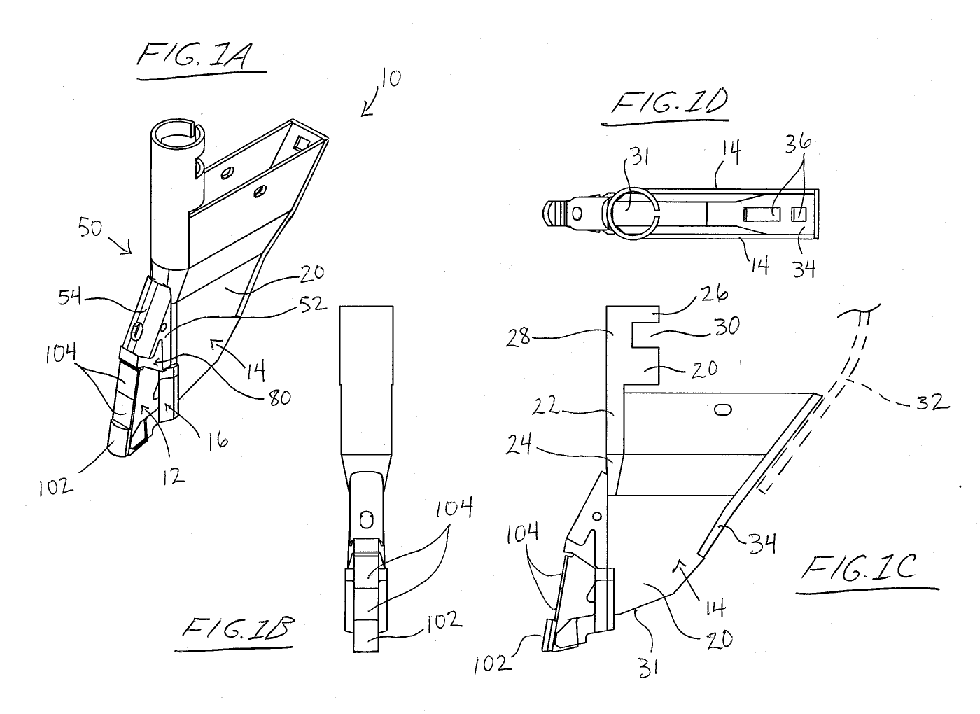

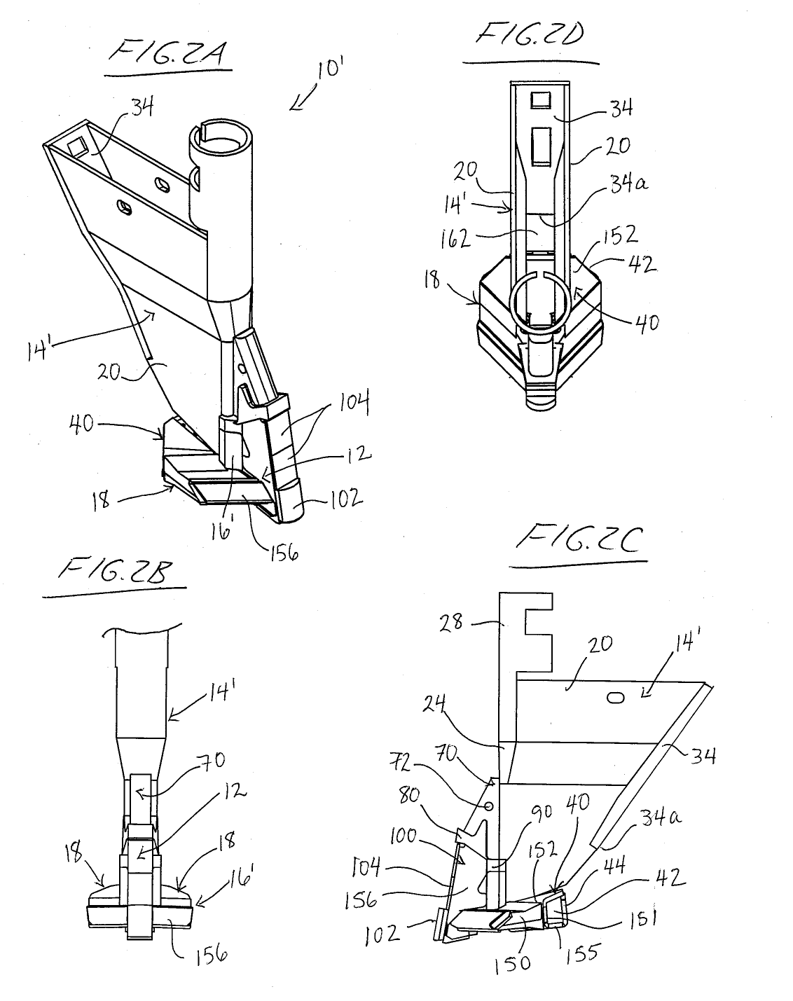

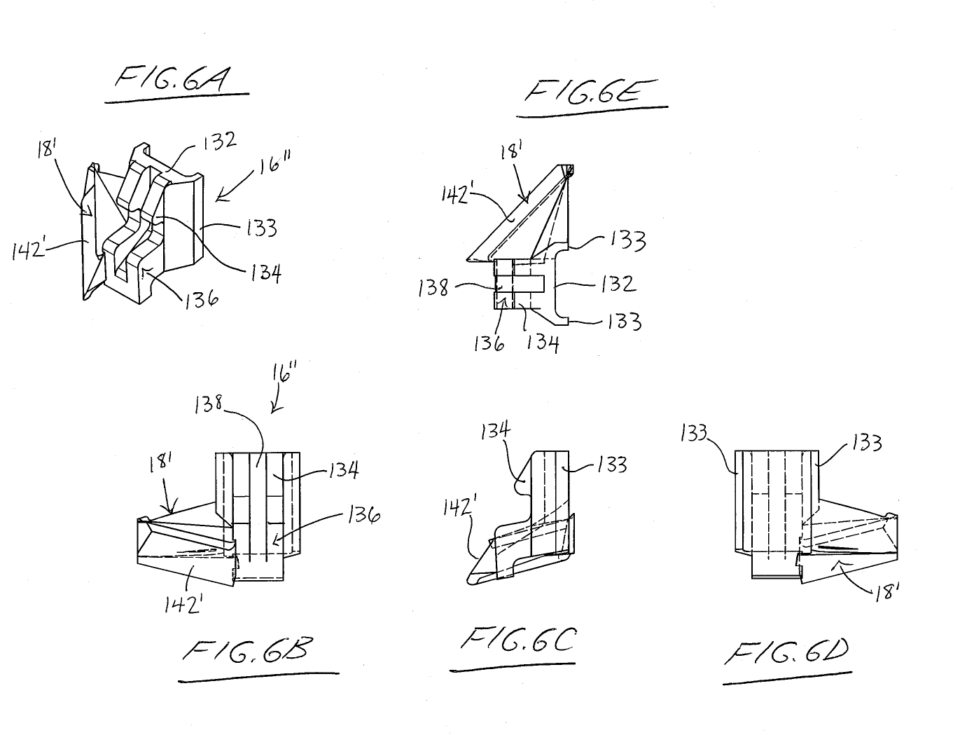

FIG. 1 shows a single shoot opener 10 of the present invention where a replaceable tip body 12 is removably mounted on a main body 14 of the opener together with a separately replaceable intermediate body 16 positioned between the tip body 12 and the main opener body 14. FIG. 2 shows a paired row opener 10′ of the present invention, which features the same replaceable tip body 12 that likewise fits together with a separately replaceable intermediate body 16′ in the same way as in the FIG. 1 embodiment, but that features two wings 18 on the intermediate body 16′ that project laterally outward on opposite sides of the tip body 12 in a position leading a respective one of two paired-row outlets of the main opener body 14′. Being a separate component from the tip body 12, the intermediate body 16′ thus allows replacement of the wing portions of the paired row opener independently of whether the tip is also being replaced. FIG. 6 illustrates a single-wing intermediate body 16″, thus demonstrating the ability to likewise replace the single-wing of a side-banding opener independently of the tip body. The similar use of an intermediate body 16 on the single shoot opener 10 of FIG. 1 illustrates how the same general two-piece removable component structure can be used even on openers that have no lateral wings, which may for example present some advantage in being able to minimize the number of distinctly unique parts that need to produced for a full product line of different style openers, as demonstrated by the use of the same tip body for the different illustrated openers.

Referring again to FIG. 1, the opener body 14 is of a general type employed in a number of opener models available from Atom Jet Industries of Brandon, Manitoba, Canada. The opener body 14 features metal-plate side walls 20 of same shape that are parallel to one another and horizontally separated to face one another across a space left between them. The side walls are somewhat wedge-shaped or triangular, widening in an upward direction from their narrower lower ends. The side walls 20 are joined together at vertical front edges of their lower halves to form a flat, vertical, lower front wall of the opener body 14. The front edges of the side walls 20 are also joined together at their top ends, but by an accurately curved upper front wall 22 that joins the side walls together from their top ends down to where the two side walls 20 converge downwardly toward one another for a short distance before returning to nearly parallel, vertical orientations at the lower halves of the walls. The front edges of the side walls 20 are also joined together at this converging intermediate section of the side walls, as generally shown at 24, down to where the lower front wall connects the lower halves of the side walls 20. The front end of the hollow space between the side walls 20 is thus closed over the full height of the side walls.

The arcuate upper front wall 22 continues upward past the top ends of the side walls, where the length of its arcuate span extends to nearly 360-degrees, and remains as such for a short upward distance, before reducing back down to about 180-degrees for another short upward distance, and then returning to a nearly full 360-degree span at its top end. The two nearly full circle spans 26 of this member above the top of the side walls 20 substantially close around a cylindrical space to define a tube into which the discharge end of a seed delivery hose can be inserted, with the smaller semi-cylindrical span 28 between these nearly full circle spans 26 leaving a slot or gap 30 at which a hose clamp can be fitted around the seed hose and semi-cylindrical span 28 to clamp the seed hose to the opener body 14. Accordingly, with the opener mounted on the shank 32 of an air seeder, and the seed hose thereof clamped to the opener 10, the end of the seed hose opens into the hollow space between the side walls of the opener body 14 just behind the closed front end of this space, whereby seed can fall from the hose through the a vertical channel that is bound on three sides by the side and front walls of the opener body so that the seed will fall through an opening 31 left between the side walls 20 at the bottom of this channel into a furrow formed by opener. Above and behind the opening 31, a rear plate 34 may close off the upwardly and rearwardly sloping edges of the side walls, and present mounting fastener-holes 36 through which the opener can be bolted to the implement shank 32.

The opener body 14′ of the paired row opener of FIG. 2 features the same configuration of side and front walls as the single shoot opener of FIG. 1, but as known in prior art openers of this type, adds an outlet chamber 40 fixed in place below the side walls, with an open top of the chamber 40 communicating with the opening between the bottom ends of the side walls so that the vertical seed channel defined between the side walls 20 opens into the outlet chamber 40. The outlet chamber projects laterally outward past the two side walls, where the rear end of the chamber is open to define respective rearward- and laterally-opening discharge or outlet openings 42 outside the two side walls 20 on opposite sides thereof. A central rear wall 44 of the outlet chamber 40 closes the rear end thereof at the central portion of the outlet chamber underlying the space between the side walls 20, thereby separating the two outlet openings 42. When seed falls from the seed tube, through the seed delivery channel between the side walls 20, and into the outlet chamber 40, the seed is divided into two separate streams respectively exiting the chamber 40 at the two outlet openings 42 at opposite laterally outward positions on the opener, thus depositing two rows (paired rows) at opposite sides of the furrow.

Another opener body similar to that of FIG. 2 may lack a rear wall, or have a reduced rear wall, at the outlet chamber, thus defining a wide-spread seeding or fertilizing opener where seed or granular fertilizer falling into the outlet chamber is discharged out of the rear end of the outlet chamber over more of its width, thus spreading seed out more fully across the width of the furrow, including the central portion thereof, instead of forming two separated rows spaced apart across this central portion of the furrow. That is, a wide spread opener may be formed with a similar structure to the paired row opener, but lacking or reducing the central rear wall of the outlet chamber, and thus having a wider overall outlet area at the rear of the outlet chamber instead of the smaller laterally-spaced rear outlets outside the two side walls.

Where the openers of the present invention differ from prior art openers of the same is in the removable nature of the tip body and intermediate body that define the leading tip and lateral wing or wings (where present) of the opener. Conventionally, the tip body and the lateral wing present in front of each laterally outward outlet 42 are rigidly fixed to the opener body, for example by welding. Accordingly, when the tip or any included wing is worn to a degree requiring replacement, the opener has been replaced as a whole. The present invention not only allows these components to be replaced, but furthermore allows the option of replacement of the tip and one or more wings at separate times. Further details on how this is accomplished in particular embodiments of the present invention are provided as follows.

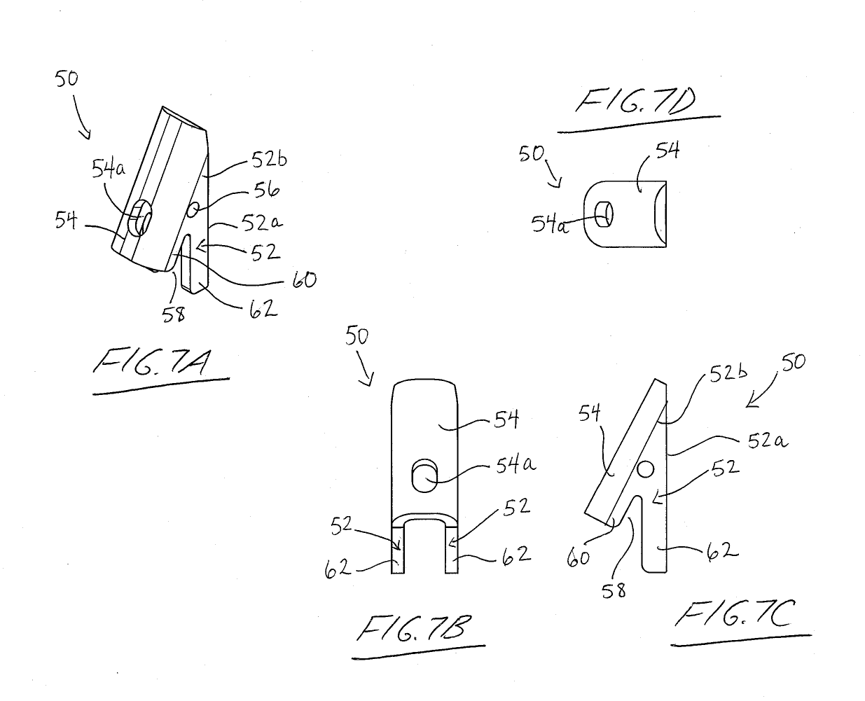

With reference to FIGS. 1 and 7, a cap piece 50 is fixed to the opener body 14 at an upper half of the lower front wall thereof, for example by welding. The cap 50 features two side walls 52 that lie generally flush with the side walls 20 of the opener body. A central span 54 joins the two cap side walls 52 together at obliquely oriented front edges thereof that slope upwardly in the rearward direction toward the opener body 14. This central span 54 may be forwardly convex, at least at the connections to the side walls on opposite sides thereof, to aid in deflection of loosened earth to either side of the opener body during conveyance thereof through the ground. The space between the cap side walls 52 beneath the central span 54 is left empty, creating a downward-opening hollow socket bound on the front/top, sides and rear by the cap's central span, the cap's side walls and the opener body's front wall. Through holes 56 pass laterally through the two side walls 52 of the cap for reasons described herein further below. The identical cap side walls 52 are somewhat arrow shaped, having a vertical rear edge 52a, and a forward/upper edge 52b sloping obliquely downward and forward from a point at the top end of the rear edge 52a. A triangular notch 58 is found in each side wall 52 between the lower halves of the vertical rear edge 52a and the sloped front/upper edge 52b, forming an obliquely oriented barb- or tang-shaped portion 60 of the side wall running along a lower portion of the central span 54, and a rectangular stem portion 62 situated across the triangular notch 58 from the barb or tang portion 60. Fixed to the front of the opener body at a distance upward from the bottom end thereof, the cap 50 defines an upper interface portion of the opener body for mating with a cooperatively shaped portion of the tip body in the manner described herein further below.

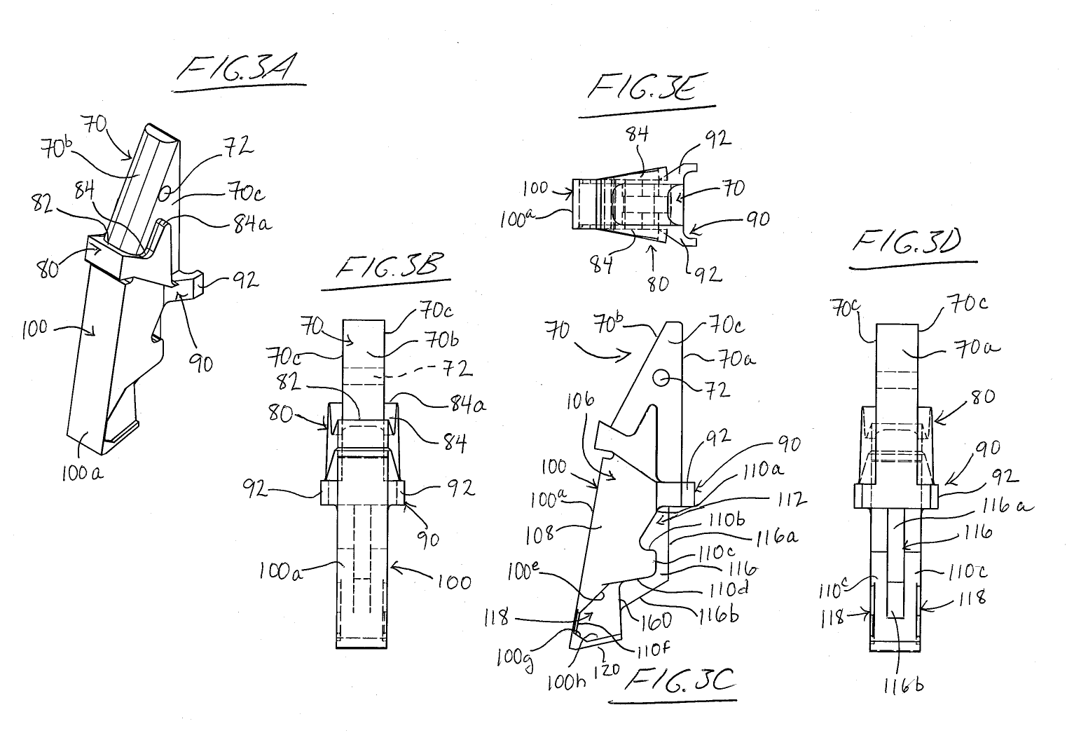

FIG. 3 shows the tip body 12 of the illustrated embodiments. A top portion 70 of the tip body 12 is triangularly shaped when viewed from a lateral position, as best shown in FIGS. 3A and 3C. This triangular top portion 70 has a flat, vertical rear face 70a, an obliquely oriented front face 70b sloping upward and rearward toward the top end of the vertical rear face 70a. The slope of the front face 70b of the top portion of the tip body 12 matches the slope of the central span 54 of the cap 50, and the front face 70b is forwardly convex on opposing sides of a flat central portion so that the front face conforms to a rearwardly concave inner side of the central span 54 of the cap. A transverse hole 72 passes fully through the triangular top portion 70 of the tip body at a position relative to the upper point of the triangular portion that matches the position of the transverse hole 56 in each cap side wall 52 relative to the upper point thereof. The width of the triangular portion between its opposing vertical sides 70c is less than the width of the opener body, and more particularly is generally equal to or slightly less than the distance between the side walls 52 of the cap 54.

Below the triangular top portion, the tip body is wider, thereby giving the triangular top portion a protrusion-like structure projecting from a wider lower portion of the tip body. With matching tapered or triangular shapes that widen in a downward direction, the upwardly projecting triangular top portion of the tip body is snugly receivable in a conforming manner inside the downward-opening socket of the cap to interface the two components together with the flat rear face 70a of the tip body's triangular upper portion against an upper portion of the vertical front wall of the opener body. A roll pin or other suitable fastener can be engaged through the holes 56 in the cap side walls and the aligning transverse through hole 72 in the upper portion 70 of the tip body 14, which secures the tip body to the cap, thereby fastening the tip body to the opener body in a fixed position as the pivoting of the tip body about the pin axis is blocked by the positioning of the tip body's upper portion 70 snugly between the vertical front of the opener body and the sloped front of the cap.

At the lower end of the front face 70b of the triangular upper portion of the tip body, a ridge portion 80 bulges outward from the triangular upper portion 70 on three sides thereof to present an upward facing, flat, central front ledge 82 spanning across the bottom of the sloped front face 72b of the triangular upper portion, and two lateral ledges 84 each projecting out from a respective vertical side 70c of the triangular upper portion. The flat front ledge 82 abuts against the lower end of the cap's central span 54 when the triangular upper portion 70 of the tip body is fully engaged in the socket of the cap 50. Each side ledge 84 is integral and continuous with the central ledge 82, first sloping downward and rearward therefrom before smoothly turning upward and rearward to catch around the barb portion 62 of the respective side wall 52 of the cap and extend into the notched out portion 58 of this side wall. The ledge 84 drops vertically off from its crest or peak 84a so that the resulting rearward facing vertical face abuts the rectangular stem portion 62 of the cap's side wall 52. The thickness of the ridge portion 80 of the tip body, i.e. the width of each ledge projecting from the triangular upper portion 70, matches or closely follows the side wall thickness of the cap 50 so that the outer faces of the ridge portion lie flush with the outer faces of the side walls and central span of the cap.

A lower half of the tip body below the ridge and triangular portions 70, 80 features an embracing portion 90 lying beneath the rear of the triangular portion 70 behind and below the rear vertical faces of the side ledges 84 that are located distance forward from the rear face 70a of the triangular portion. On each side of the triangular portion 70, the embracing portion 90 features a respective arm 92 branching laterally outward therefrom flush with the rear face 70a of the triangular portion and then turning rearward, so that the two arms 92 form a C-shaped or square-bracket shaped channel for embracing about the lower front wall of the opener body 14 a short distance over the respective side walls 20 thereof.

The lower half of the tip body 12 also defines a furrowing portion 100 depending downwardly and forwardly from the ridge and embracing portions 80, 90 to present a steeply sloped front face 100a which extends downward past the bottom end of the opener body 14. With reference to FIGS. 1 and 2, the illustrated embodiments feature a carbide tip piece 102 featuring a flat back for flush placement against the front face 100a of the tip body's furrowing portion at the bottom end thereof, and a convex or pointed front face. Also mounted flush to the front face 100a of the furrowing portion are two additional carbide pieces 104 situated one over the other above the carbide tip piece 102. Mounted at the leading front face of the tip body, the carbide pieces define the leading edges and surfaces of the opener, particularly at the tip piece 102 that forms the leadingmost and lowermost tip of the entire assembly.

At each vertical side 106 of the furrowing portion 100, the laterally outermost surface 108 extends rearward from the front face 100a. The rear edge 110 of this outermost surface has a profiled shape, first sloping down and forward at 110a from the respective arm 92 of the embracing portion 90, then turning horizontally rearward at 110b before turning vertically downward at 110c, from which it then slopes forward and downward again at 110d, but at a less angle than at the edge's upper end. This forms a nose-shaped or triangular notch 112 jutting into the furrowing portion from the rear end thereof at each side thereof immediately below the embracing portion 90, and a rearward jutting stub 114 located beneath the nose-shaped notch 112. The rear edges 110 of the laterally outermost side surfaces 108 of the furrowing portion are not directly joined with another. That is, the rear edge 110 of each outermost side surface 108 is defined by a recessed area on each side of a central remainder of the furrowing portion that defines a tongue 116 that projects rearward from the rear edges of the outermost side surfaces and separates the recessed areas on opposing sides of the tip body. This tongue 116 has a vertical rear edge 116a positioned parallel to, but forwardly spaced from, the rear face 70a of the tip body's upper triangular portion 70. The rearward jutting stub 114 of the laterally outermost face on each side 106 of the furrowing portion stops short of reaching the rear edge of the tongue 116.

The depth of the recessed areas on each side of the tip body takes a single-step decrease 160 at an intermediate position along the bottom 110d of the rearward jutting stub 114, where the furrowing portion 100 continues downwardly past a bottom edge 116b of the tongue 116. The boundaries of this shallower recess 118 slope downward and forward at 110e from the bottom 110d of the rearward jutting stub 114 to near the front face 100a of the furrowing portion 100, where the next boundary edge 110f slopes more steeply downward along the front face of the furrowing portion 100, before the next recess boundary 110g slopes downward and rearward to the final boundary edge 110h, which slopes upward and rearward parallel to the upward and rearwardly sloped bottom end 120 of the furrowing portion. The arrangement of recessed side areas and the failure of the tongue 116 to reach the plane of the vertical rear face 70a of the upper triangular portion 70 of the tip body mean that when the triangular upper portion 70 is received in the socket of the cap 50 with the rear face 70a situated against the front wall of the opener body, spaces are left between the rear features of the tip body and the lower half of the opener body's front wall to accommodate mating features of the intermediate body, which are now described in the following passages.

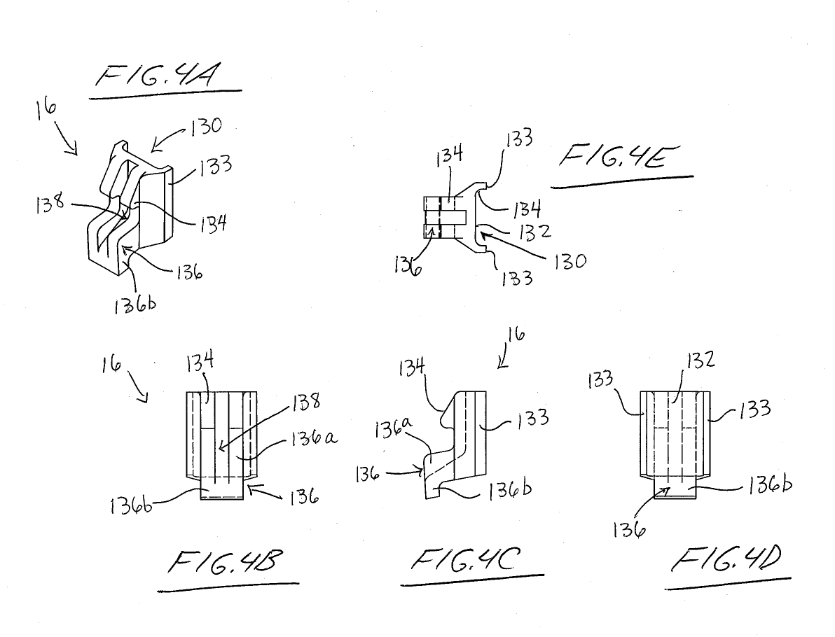

FIG. 4 shows the simplest of the illustrated intermediate bodies, particularly the wingless intermediate body 16 for the single shoot opener of FIG. 1. A rear portion 130 of the intermediate body 16 is configured with the same horizontal cross-sectional shape as at the embracing portion 90 of the tip body 12. That is, a flat vertical wall 132 faces rearwardly in a central portion between lateral arms 133 that bend rearwardly from the central vertical wall 132 to form a C-shaped or square-bracket shaped channel that embraces about the front wall of the opener body a short distance rearwardly over the side walls 20 thereof when the central vertical wall 132 of the intermediate body 16 is placed flush against the opener body's front wall. From the opposing front side of the vertical wall 132, a pair of identical nose-shaped or triangular projections 134 jut forwardly from the vertical wall 132, sloping downward and forward from the top end thereof to an intermediate position part way down the wall 132. At a distance beneath and a position inline with each of these vertically oriented jutting features 134 is a respective L-shaped wall 136 projecting first forwardly, and slightly downwardly, from the vertical wall, down to the bottom end thereof, and then turning through a right angle to extend more steeply downward. The spacing between the nose-shaped projections 134 and the matching spacing between the L-shaped wall projections 136 defines a slot-shaped opening 138 running up and down along the front of the intermediate body 16. The vertical wall 132 closes off the rear of this slot 138, and a joining together of the L-shaped wall projections at their downward depending second legs 136b and over a partial height of their forwardly jutting first legs 136a closes off a bottom of this slot 138, leaving the slot open from above and in front. As perhaps best shown by the broken lines in FIG. 4C, the closure of the bottom of the slot 138 may slope downwardly and forwardly at an angle matching the slope of the bottom end 116b of the tongue 116 of the tip body 12 (FIG. 3C).

The rear of the tip body and the front of the intermediate body are thus conformingly shaped to mate together when interfaced in suitable alignment. The nose-shaped projections 134 jutting forward from the intermediate body fit into the nose-shaped notches or recesses 112 at the rear of the tip body 12. This engagement also acts to fit the rearward projecting stub 114 at each side of the tip body into the respective gap between the nose-shaped and L-shaped projections of the intermediate body, to fit the L-shaped projections 136 into the recess areas below the rearward jutting stubs 114 of the tip body, and to fit the tongue 116 of the tip body 12 into the slot 138 of the intermediate body. This fitting of the tongue 116 between the projections of the intermediate body prevents relative lateral displacement between the tip body and intermediate body when mated together, while the fitting of the rearward jutting stubs 114 between the projections on the intermediate prevents relative vertical displacement between the mated components. The upward and rearward slope of the bottom of the tip body's tongue and the bottom of the intermediate body's slot give cause these features to taper in height in a rearward direction, thus easing the process of inserting the tongue into the slot, as the shorter rear end of the tongue easily slips into the taller front end of the slot.

Referring to FIG. 1, to assemble the tip and intermediate bodies onto the opener body, the forward side of the intermediate body 16 is matingly interfaced against the rear side of the tip body 12, and the two components are slid together along the vertical front wall of the opener body 14 upward into the downward-opening socket of the cap 50, at which point the roll pin is pressed into the aligned holes in the cap and the triangular upper portion of the tip body to fasten the tip body to the opener body. Due to the mating engagement of interlacing features among the tip body and intermediate body, this single fastener also acts to automatically fasten the intermediate body in place between the opener body and tip body. More particularly, the position of the nose-shaped projections of the intermediate body atop the rearward jutting stub of the tip body acts to hang or suspend the intermediate body from the tip body, while the cap prevents rotation of the tip body about the pin axis, thereby keeping the lower end of the tip body fixed in a position clamping the intermediate body between the tip body and the opener body. In this installed position, the intermediate body's vertical wall 132 is clamped flush against the lower half of the front vertical wall of the opener body 14, which thus defines a lower interface portion of the opener body 14 for mating receipt of the intermediate body when the tip body is mated to the upper interface portion defined by the cap 50.

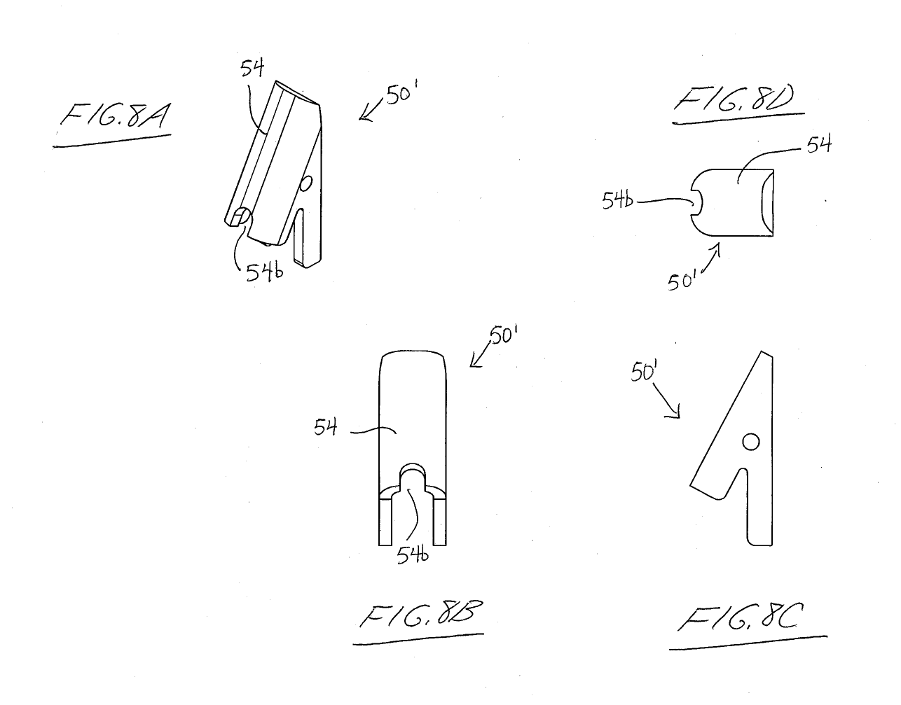

To aid in later disassembly of the bodies, for example to enable replacement of one or both of the tip and intermediate bodies, the cap 50 may feature a through hole 54a in the central span 54 at the front of the cap through which a punch can be driven downward to help knock the triangular upper portion 70 of the tip body loose from within the socket of the cap. FIG. 8 shows an alternate cap embodiment 50′ which features a notch 54b jutting up into the central span 54 from the front bottom edge thereof for the same purpose of knocking the tip body free from the cap during disassembly of components from the opener body. The upper triangular portion of the tip body may feature a dimple suitably placed in the front face thereof to reside under the through hole 54a or notch 54b of the cap in order to seat the end of the punch in a stationary position on the tip body to focus the punching action into a driving force knocking the tip body free by preventing sliding or skidding of the punch along the front face of the tip body's triangular upper portion. Other embodiments may lack any cap opening or notch for aiding in release of the tip body, instead maintaining a closure of the full front side of the cap socket.

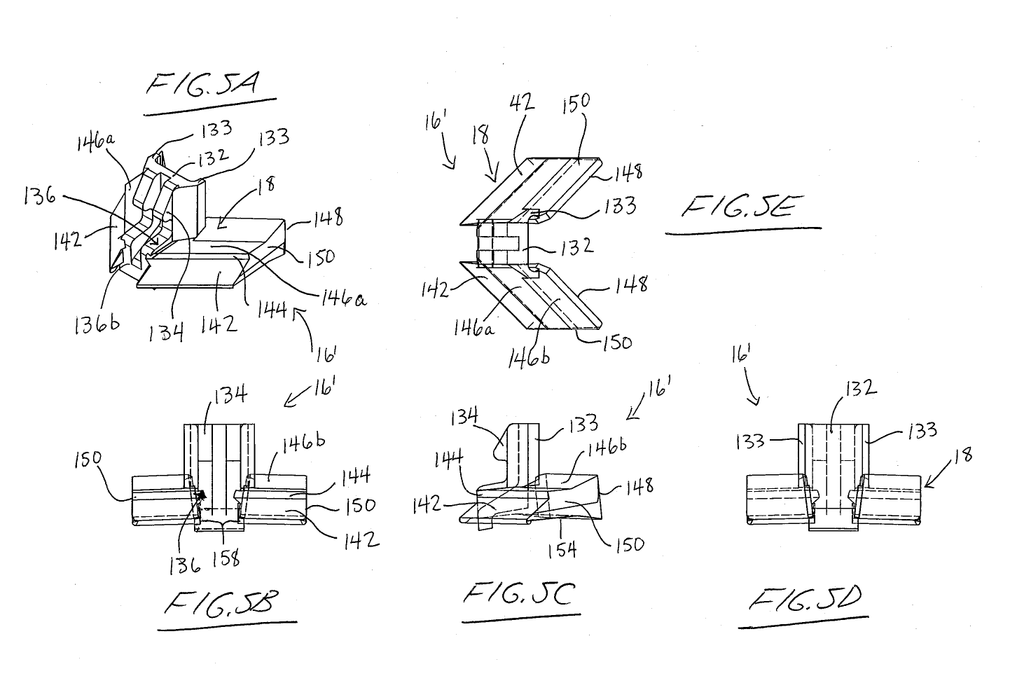

The paired row opener 10′ of FIG. 2 is assembled in a manner similar to that described above for the single shoot opener of FIG. 1, using the same cap (not shown in FIG. 2) fixed in place at the front wall of the opener body and the same tip body 12 for mating and fastening with the cap in a manner securing the intermediate body in place between the tip and opener bodies. The paired row intermediate body 16′ of the FIG. 2 embodiment, shown in isolation in FIG. 5, features a central mounting portion of the same form as the single shoot intermediate body 16 of FIGS. 1 and 4, but additionally features a pair of wings 18 projecting laterally from the central mounting on opposite sides thereof so as to extend laterally outward relative to the side walls 20 of the opener body 14′ in front of the respective laterally projecting portions of the outlet chamber of the opener body 14′.

Each wing 18 sweeps rearward as it extends laterally outward from the central portion of the intermediate body 16′. A front surface 142 of each wing is obliquely oriented to slope upward from front to back. At the rear end of this front surface 142, an abutment 144 juts perpendicularly upward a short distance from the front surface. From the top end of this abutment 144, a first top surface 146a of the wing runs horizontally rearward, from which a second top surface 146b slopes upward and further rearward to a rear end 148 of the wing 18. The rear end of the wing sweeps rearward and laterally outward from just behind the central mounting portion of the intermediate body 16′. The outer lateral edge 150 of each wing 18 lies generally parallel to the side walls 20 of the opener body 14′, giving each wing a parallelogram appearance in plan view, as seen in FIG. 5E. As best shown in FIG. 2C, when the intermediate body 16′ engaged in place between the tip body and the opener body in the manner described above for the single shoot embodiment, the rear face 148 of the wing abuts against a lateral and rearward sweeping front wall 151 of the respective side of the outlet chamber 40, with the rear top surface 146b of the wing lying flush with a top wall 152 of this lateral portion of the chamber 40. The bottom wall 154 of the wing lies at or near the plane of a bottom wall 155 of the outlet chamber that spans fully thereacross. As shown in FIG. 2, a parallelepiped tungsten carbide piece or insert 156 lies flush atop the front surface 142 of each wing and occupies all, or substantially all, of the area of this surface, with a rear upper edge of the carbide insert 156 residing against the abutment 144 over at the least the full height thereof at the rear of this front wing surface 142.

Each wing 18 wraps slightly inward about the front end of the central mounting portion at the downturned leg 136b of the respective L-shaped projection 136 of the mounting portion, where the inner edge of the front surface 142 extends downward and forward from the downturned leg 136b of the L-shaped projection 136. This leaves a gap between the resulting forward-jutting front/inner corners 158 of the two wings 18 immediately in front of the central mounting portion. Turning again to FIG. 3, the shallower recess 118 in the sides of the furrowing portion of the tip body accommodate these forward-jutting front-inner corners 158 of the wings 18 of the intermediate body 16′ ahead of where the exposed remainder of the front faces of the L-shaped projections 136 of the intermediate body abut against the surfaces 160 of the tip body that transition from the tongue 116 to the rear of these shallower recesses 118. The carbide insert 156 of each wing likewise has its inner end received in the shallow recess 118 at the respective side of the tip body, with the front face of the carbide insert 156 fitting flush with the sloped front upper boundary 110e of the recess 118. Recessing of the wings and associated carbide pieces slightly into the sides of the tip body avoids exposed cracks or gaps between the components, thereby preventing weeds, straw, soil, etc. from washing through such gaps and causing wear, and also protecting the front corner of the carbide from chipping.

The opener of FIG. 2 operates as follows. The wings 18 of the intermediate body ride in positions leading the respective lateral outlets of the outlet chamber 40 below the side walls 20 of the opener body. As the opener is moved through the earth, the lower- and forward-most tip at the bottom front of the tip body creates a furrow of width equal or similar that occupied by the sidewall-bound portion of the opener body above the outlet chamber 40. The carbided wings 18 on the intermediate body, with their inner forward points situated just behind the carbide tip of the tip body, are situated a short elevation above the lowermost extent of the tip. Soil that is located laterally outward from the tip on each side thereof is displaced up over the respective wing, and rearwardly onward over the respective side of the outlet chamber 40. With the opener moving forward through the ground, and seed falling into the outlet chamber through the seed tube and seed channel at the front of the interior space of the opener body, the seed exits the opener body at the lateral outlet openings of the outlet body 40, where the soil being deflected thereover then falls back in place over the deposited seed. The two lateral outlets provide a pair of seed rows spaced apart across a deeper central portion of the furrow formed by the tip body, and situated a short distance above this deeper central portion of the furrow.

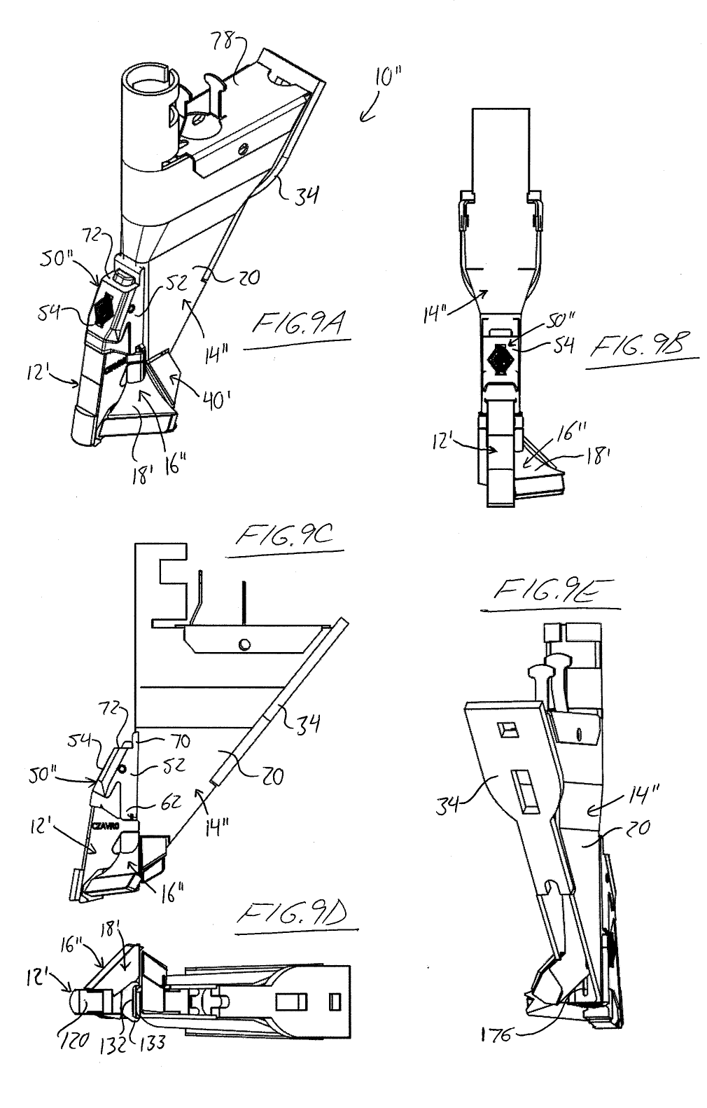

The interior space bound between the side walls of the opener body 14′ may be divided into front and rear portions, the front portion defining the seed delivery channel whose bottom end empties into the outlet chamber for lateral discharge of seed on opposite sides. The rear portion may be open at the bottom end thereof between the rear of the outlet chamber and a lower end 34a of the rear plate 34 of the opener body, as shown at 162 in FIG. 2D. This way, a cover (like that shown at 78 of FIG. 9) fitted over the open space between the side walls 20 may employ a second tube or opening for insertion of a fertilizer delivery hose to deliver granular fertilizer into the into the deeper central portion of the furrow through the rear channel defined between the opener side walls 20 behind the seed tube.

FIG. 6 shows a third embodiment replacement body 16″ having the same central mounting portion, but featuring only a single wing structure 18′ projecting to one side thereof for use on a side-banding opener similarly having only a single lateral outlet. While FIG. 6 shows a right-hand side-banding configuration, it will be appreciated that a similar left-hand configuration with the single wing on the other side may also or alternatively be produced. A first material (e.g. fertilizer) can be delivered down through a channel or conduit at the front end of the open space between the side walls of the opener body for discharge to one side of the opener body through a one-sided outlet chamber fixed in place below the side walls, while a second material (e.g. seed) can be delivered through a rear channel defined between the side walls further back along the opener, as described above for the second (paired row) embodiment. The lateral-discharge on one side thus forms a side band of fertilizer running along one side of the centrally deposited seed. The wing 18′ in this embodiment differs from those of the previous embodiment in that the lower front edge of the front surface 142′ is situated lower than the previous embodiment, with the wing 18′ reaching downwardly past the lower end of the downturned legs 136b of the L-shaped projections 136 of the central mounting portion of the intermediate body. This way, the leading edge of the wing is situated at, or at least nearer to, a horizontal plane containing the lowermost extent of the opener tip. Accordingly, the wing's cutting action through the soil to create a bed on which the fertilizer is deposited (before the soil falls back in place behind the lateral fertilizer outlet) is situated on the same plane as the centrally deposited seed row. Referring to FIG. 2, where it can be seen that the shallow recesses 118 in the sides of the tip body near the lower front end thereof are of greater size than needed to accommodate the particular wing configuration of that embodiment, this oversizing of the recesses 118 is preferred in order to provide sufficient height and suitable shape to accommodate different wing configurations for same plane, or separate plane, deposit of different materials, e.g. seed and fertilizer. This way, different intermediate bodies differentiated by their wing configurations can all be functionally cooperate with the same type of tip body.

Accordingly, not only does the present invention allow for optional separate replacement of the tip and wing(s) of an opener, and provide a simple one-point-fastening arrangement whereby the two components are held in place by a single pin, but the present invention offers efficient manufacturing options by employing a standard tip-body design that can be employed in different opener types simply by cooperating with different intermediate-body types.

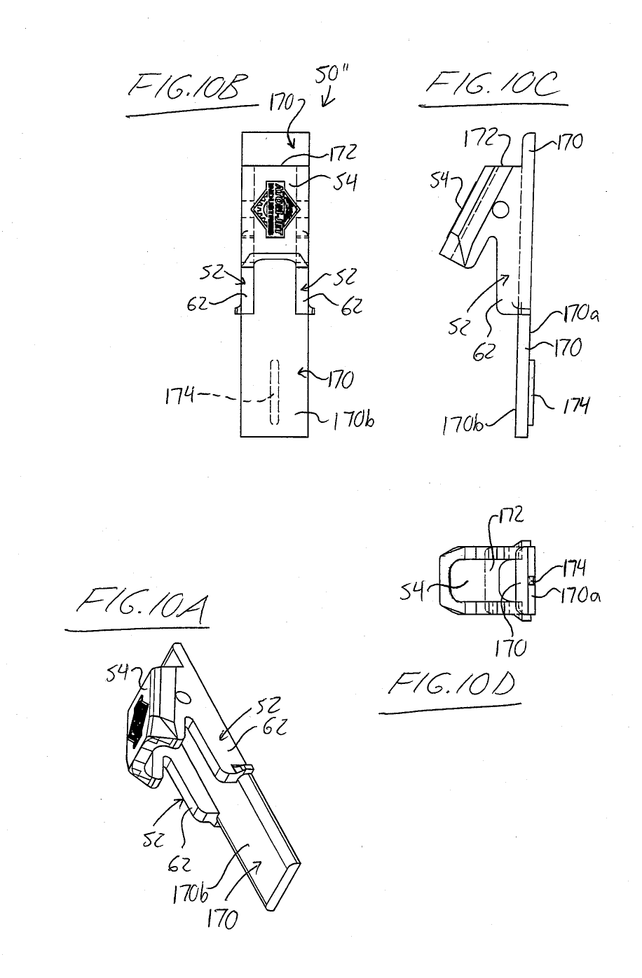

FIGS. 9 and 10 illustrate side banding opener 10″ employing a tip body 12′ similar to the openers of FIGS. 1 and 2. The opener features a main opener body 14″ and single-wing intermediate body 16″ that are similar to those of FIG. 2, but with the single wing 18′ of the intermediate body 16″ and the outlet chamber 40′ of the opener body being disposed on the side the opener opposite that of FIG. 2. Where this side banding opener 10″ is most notably different fro the preceding embodiments is in the cap piece 50″.

With reference to FIG. 10, the cap piece 50″ features the side walls 52 and central span 54 of the earlier embodiments, but additionally features a vertical backing plate 170 that joins the two side walls 52 together over the full heights thereof in a plane perpendicular to the side walls 52, and continues downward past the lower ends of the rectangular stem portions 62 of the two side walls 52. The top ends of the side walls 52 and the upper end of the central span 54 are slightly truncated in relation to the earlier embodiments, as a horizontal top wall 172 juts a short distance forward from the backing plate 170 and spans between the top ends of the two side walls 52. In the illustrate embodiment, the backing plate 170 projects a upwardly past this top wall 172, but by a smaller distance than it extends downward past the lower ends of the rectangular stem portions 62 of the side walls 52. A longitudinal protrusion 174 juts from an otherwise flat rear face 170a of the backing plate 170, thus forming a vertically-running rib or ridge that projects to the side of the backing 170 opposite that to which the side walls 52 forwardly extend.

With reference to FIG. 9E, the main opener body 14′ is provided with a vertical slot 176 in the lower front wall of the main opener body near the lower end thereof. As shown, the slot 176 may extend fully through the lower front wall of the main opener body 14′. In other embodiments, the slot may be recessed into the front face of the front wall without passing fully therethrough. The slot is dimensioned to receive insertion of the cap's rear face protrusion 174 during manufacture of the opener, thereby positively positioning the cap piece on the main opener body at the appropriate position thereon for welding thereto. The slot and protrusion thus define alignment features by which proper positioning of the cap can be accomplished with reduced or eliminated reliance on complicated jigs and welder skill to hold the pieces in place during the welding process. The backing plate 170 of the installed cap spans over the flat lower front wall of the opener body 14′. Although FIG. 9E shows the through-slot 176 as being visible inside the opener body 14′ from the rear thereof, the slot and mated protrusion of the cap may be concealed by welding material used to join the main body 14″ and cap 50″ during production.

Assembly of the tip body and intermediate body to the cap-equipped opener body is the same as the preceding embodiments, except that the rear face 70a of the upper triangular portion 70 of the tip body and the rear face of the vertical wall 132 of the intermediate body 16 are not placed flush against the flat front wall of the opener body 14″, but instead abut flush against a flat front face 170b of the backing plate 170 of the cap piece 50″. The arms 92 of the intermediate body thus embrace about opposite side edges of the backing plate 70. One motivation for wanting to use a backing plate of the welded cap piece to form the rear support for the removable tip body and intermediate body is that a higher precision of flat-surface uniformity may be attainable in manufacture of the cap piece, for example by casting, than in the metal-forming process used to fabricate the above-described type of opener body 14″ by bending it into shape from an initially flat plate, thus allowing for more consistent, flush abutment between the assembled pieces in order to provide maximum strength to the assembled opener.

While detail has been given in the forgoing embodiments concerning the use of particular mating/conforming shapes and configurations for the fitting together of the tip, intermediate and opener bodies in a cooperable manner, it will be appreciated that variations may be employed to achieve similar result. For example, the illustrated embodiments employ a cap with a hollow socket into which a projecting feature on the tip body engages, and a slot in the intermediate body into which a tongue of the tip body engages. Another embodiment may reverse one or both of these configurations, for example having the hollow socket and slot features on the tip body and mating projecting features on the opener and intermediate bodies. Another embodiment may employ separate fasteners for connecting separately replaceable tip and intermediate bodies to the opener body, although the one-step fastening of the illustrated embodiments is preferred for ease of installation and removal of components.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A furrow opener for mounting on an agricultural implement shank for movement therewith in a forward working direction, the furrow opener comprising:
an opener body including a shank mount arranged to support the opener body on the implement shank, and upper and lower interface portions at a forward side of the opener body;
a tip body comprising:
a top interface portion adjacent an upper end of the tip body and arranged for mating with the upper interface portion of the opener body so as to interface the tip body with the opener body at a distance upward from a bottom end of the opener body;
a rear accommodating portion defined at the rear side of the tip body below the top interface portion and arranged to define an accommodating space between the lower interface portion of the opener body at the forward side thereof and the rear accommodating portion of the tip body with the top interface portion of the tip body mated with the upper interface portion of the opener body; and
a furrowing portion extending downwardly and forwardly from the accommodating portion to reach beyond the bottom end of the opener body so as to be arranged to form a furrow in the ground; and
an intermediate body comprising a mounting portion arranged to interface with the rear accommodating portion of the tip body and the lower interface portion of the opener body to fit in the accommodating space defined therebetween.

2. The furrow opener of claim 1 wherein a rear side of the intermediate body is arranged to embrace about the forward side of the opener body onto opposing lateral sides thereof.

3. The furrow opener of claim 1 wherein the tip body comprises an embracing portion at the rear side thereof, which is arranged to embrace about the forward side of the opener body onto opposing lateral sides thereof.

4. The furrow opener of claim 3 wherein the embracing portion of the tip body is disposed below the top interface portion and above the rear accommodating portion.

5. The furrow opener of claim 1 wherein the top interface portion of the tip body and the upper interface portion of the opener body comprise opposite ones of a socket and a projection matably receivable in said socket.

6. The furrow opener of claim 5 wherein the upper interface portion of the opener body comprises the socket, which opens downward and comprises side walls for fitting over respective lateral sides of the projection, which extends upwardly on the tip body.

7. The furrow opener of claim 6 comprising aligned holes passing through the side walls of the socket, a corresponding through hole passing transversely through the projection at a position aligning with the aligned holes of the socket when the projection is matingly received therein, and a retaining pin for passage through the aligned holes of the socket and the through hole of the projection when same are aligned.

8. The furrow opener of claim 5 wherein the socket and the projection are wedge-shaped to each grow wider moving in a downward direction.

10. The furrow opener of claim 1 wherein a rear side of the intermediate body and the lower interface portion of the opener body feature opposite ones of a slot and a tongue matably receivable in said slot.

11. The furrow opener of claim 1 wherein the intermediate body comprises a forward jutting feature at a front side thereof and the tip body comprises a rearward jutting feature at the rear accommodating portion thereof, the forward jutting feature of the intermediate body being arranged to fit over the rearward jutting feature of the tip body to suspend the intermediate body from the tip body.

13. The furrow opener of claim 1 wherein the intermediate body is one of a plurality of intermediate bodies each comprising a respective said mounting portion arranged to fit within the accommodating space between the tip body and the opener body, and each having a different respective number, between zero and two, of wing portions each projecting laterally outward from the respective mounting portion on a respective lateral side thereof, whereby the intermediate body is selectable from among the plurality of intermediate bodies according to a numbering and positioning of product discharge locations on the opener body.

14. The furrow opener of claim 1 wherein the intermediate body has a single wing portion projecting laterally outward from the mounting portion on only one side thereof, and the opener body has a lateral discharge opening on only one side thereof in a position trailing the single wing portion of the intermediate body.

15. The furrow opener of claim 1 wherein the intermediate body has a pair of wing portions projecting laterally outward from the mounting portion on opposite sides thereof, and the opener body has a pair of lateral discharge openings on opposing sides thereof in positions respectively trailing the wing portions of the intermediate body.

16. The furrow opener of claim 1 wherein the intermediate body is free of any wing portions projecting laterally outward from the mounting portion thereof, and the opener body has a central discharge opening in a position trailing the mounting portion of the intermediate body.

17. The furrow opener of claim 1 wherein the tip body and the intermediate body are arranged to be secured in place relative to the opener body through fastening of only a single fastener.

18. The furrow opener of claim 17 wherein the single fastener engages with the opener body and only one of said tip body or said intermediate body.

18. The furrow opener of claim 1 wherein the intermediate body is arranged to be clamped in place between the tip body and the opener body under fastening of the tip body to the opener body with the intermediate body in the accommodating space, without additional fastening of the intermediate body to either the tip body or the opener body.

19. The furrow opener of claim 17 comprising a fastening arrangement operable to fasten the tip body to the opener body where the upper interface portion of the opener body mates with the top interface portion of the tip body.

20. A method of mounting a tip body on an opener body of a furrow opener in which the opener body comprises a shank mount arranged to support the opener body on an agricultural implement shank for movement therewith in a forward working direction, the method comprising:
positioning the tip body together with an intermediate body such that a top interface portion of the tip body engages with an upper interface portion at a forward side of the opener body, a rear side of the tip body engages with a front side of the intermediate body, a rear side of the intermediate body engages with the forward side of the opener body below the engagement between the top interface portion of the tip body and the upper interface portion of the opener body, and a furrowing portion of the tip body extend downwardly and forwardly from the engagement thereof with the intermediate body to extend past a bottom end of the opener body; and
fastening at least one of the tip body and the intermediate body to the opener body.
